(19) United States
(12) Patent Application Publication
(10) Pub. No.: US 2007/0041762 A1
(43) Pub. Date: Feb. 22, 2007

(54) IMAGE PRINTING APPARATUS

(75) Inventors: Yujiro ISHIDA, Tokyo (JP); Satoshi HAMAYA, Tokyo (JP); Hideo ISOHARA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/423,184

(22) Filed: Jun. 9, 2006

(30) Foreign Application Priority Data
Aug. 22, 2005 (JP) 2005-239733
Mar. 20, 2006 (JP) 2006-076263

(51) Int. Cl. G03G 15/00

(52) U.S. Cl. 399/388

(57) ABSTRACT

The present invention provides an image printing apparatus which comprises registration roller unit which convey an image recording sheet toward an image transfer position at which the toner image is transferred onto the image recording sheet, a sensor which is provided between the registration roller unit and the image transfer position to detect the image recording sheet, and a control unit which controls driving of the registration roller unit. In order to make the time required for each image recording sheet to reach the image transfer position constant, the image printing apparatus is adapted to start the driving of the registration roller unit at the first sheet convey speed higher than the linear speed of the surface of the image carrier, measure the time required until the leading end of a conveyed image recording sheet is detected by the sensor after a driving signal for the registration roller unit is output, and reduce the sheet convey speed of the registration roller unit to the second sheet convey speed at the timing based on the measurement result.

### CROSS-REFERENCE TO RELATED APPLICATION

This application makes reference to, incorporates the same herein, an claims all benefits accruing under 35 U.S.C. §119 from an application for IMAGE PRINTING APPARATUS earlier filed in the Japanese Patent Office on Aug. 22, 2005, and there duly assigned the application No. 2005-239733.

### BACKGROUND OF THE INVENTION

1. Field of the Invention

The present invention relates to an image printing apparatus such as a copying machine, printer, or facsimile apparatus and, more particularly, to an image printing apparatus which can convey an image recording sheet to an image transfer position at a constant arrival time so as to transfer a toner image carried on an image carrier onto a predetermined position on the image recording sheet with high accuracy.

2. Description of Related Art

An image printing apparatus designed to transfer a toner image carried on an image carrier such as a photosensitive drum or an intermediate transfer body onto an image recording sheet.

In such an image printing apparatus, registration roller unit are generally provided upstream of the image transfer position where image transfer members such as a transfer electrode and a transfer roller are arranged.

The registration roller unit have a function of correcting the skew of the leading end of an image recording sheet conveyed from a paper feed unit with respect to the convey direction by abutting the image recording sheet against the rollers and a function of conveying the image recording sheet to the image transfer position at the timing of an image printing process, i.e., a predetermined timing matching a toner image carried on the image carrier.

Even if, however, the driving of the registration roller unit is tried to be controlled at a predetermined sheet convey speed, the time taken to convey an image recording sheet to the image transfer position varies due to speed fluctuations caused by power fluctuations in a drive source which drives the registration roller unit.

In addition, slip occurs between an image recording sheet and the registration roller unit due to the wear of the surfaces of the registration roller unit over time or the like. As a result, even if the driving of the registration roller unit is started, the conveyance of the image recording sheet is not immediately started, resulting in a delay of the time taken to convey the image recording sheet to the image transfer position. In addition, when an image recording sheet is stopped by being abutted against the registration roller unit, the insertion amount of the image recording sheet into the nip portion of the registration roller unit sometimes changes. If, for example, the insertion amount of the image recording sheet into the nip portion is large, the image recording sheet is conveyed beyond a predetermined stop position. If, therefore, the image recording sheet is conveyed from this position to the image transfer position, the convey time is quickened. In contrast to this, if the insertion amount of the image recording sheet into the nip portion is smaller, the image recording sheet has not reached the predetermined stop position. If, therefore, the image recording sheet is conveyed from this position to the image transfer position, the convey time is delayed.

If the convey time required for an image recording sheet to reach the image transfer position is caused to become unstable due to such various factors, a toner image cannot be transferred onto a predetermined position on the image recording sheet. As a result, an image shift occurs between image recording sheets or an image position shift occurs between the obverse/reverse surfaces of an image recording sheet. As a result, the quality of printed images becomes poor.

When an image printing apparatus is used as a quick printer, in particular, the accuracy of image positions with respect to image recording sheets are required to be very high.

In order to solve the above problems, for example, the techniques disclosed in Japanese Unexamined Patent Publication Nos. 4-134358 (patent reference 1) and 2002-187644 (patent reference 2) have been proposed.

Patent reference 1 discloses a drive control scheme for registration roller unit in an image printing apparatus in which registration roller unit are provided at a preceding portion of a printing unit, and a sensor which detects an image recording sheet is placed between the registration roller unit and the printing unit to drive the registration roller unit in accordance with the timing of a toner image formed on an image carrier. This scheme is provided with a driving unit which sets a constant arrival timing at the printing unit and a constant sheet convey speed for image recording sheets by increasing the driving speed step by step. In this driving unit, the driving speed is controlled by a timer set by general software up to two steps before the final speed to set the time during which the registration roller unit are driven at the speed immediately before the final speed by calculating the difference between the time required to actually feed the image recording sheet when the leading end of the image recording sheet is detected by the sensor and a predetermined reference time. In such a drive control scheme for registration roller unit, since variations in the movement of an image recording sheet at the time of driving the registration roller unit can be absorbed by the control timing set by a controller, a good copy without any image shift can be formed.

According to patent reference 2, the following control is executed. The loop hold time is set to 0, and the sheet convey speed with the registration roller unit is set to be higher than the image printing speed of the image printing unit at the start of conveyance. Thereafter, before a conveyed image recording sheet reaches the image printing unit, the sheet convey speed is reduced to almost the same speed as the image printing speed by detecting in advance the time required for the image recording sheet to reach the registration roller unit from pre-registration roller unit using a sensor provided immediately before the registration roller unit and changing the speed reduction timing of the registration roller unit on the basis of the detection result. With this control, the image recording sheet interval can be reduced, and position correction can be performed with respect to image positions on image recording sheets by the time during which the conveyance start speed of the registration roller unit is held high.

The drive control scheme for registration roller unit disclosed in patent reference 1 is multi-step acceleration control of obtaining a stable image printing speed by starting to drive the registration roller unit at a low speed and then accelerating the speed in multiple steps. According to this technique, since there is an area where an image recording sheet is conveyed at a low speed, the productivity of copies is low. That is, the technique is not suitable for high-speed image printing operation, i.e., a high-speed apparatus. In addition, if a stepping motor is used to change the sheet convey speed, it takes much time to stabilize the speed, and there is a time accompanied by speed fluctuations. As a consequence, the accuracy of the time taken to convey an image recording sheet to the image transfer position deteriorates to cause a positional shift. For this reason, the technique disclosed in patent reference 1 is designed to eliminate speed fluctuations by changing the speed in multiple steps, but cannot satisfy the requirement for accurate conveyability.

The convey method disclosed in patent reference 2 is designed to eliminate a convey time shift in a convey step of conveying an image recording sheet from the pre-registration roller unit to the registration roller unit by changing the speed reduction timing of the registration roller unit. However, no consideration is given to a convey time shift in a convey step on the downstream side of the registration roller unit. That is, a convey time shift occurs due to speed fluctuations in the registration roller unit or a slip between an image recording sheet and the registration roller unit. However, since a convey time shift on the downstream side of the registration roller unit cannot be corrected, the positional shift of an image printed on the image recording sheet cannot be eliminated.

### SUMMARY OF THE INVENTION

In consideration of the above situation, the present inventors compared and examined a case wherein a stabilized speed was obtained by acceleration from a low speed and a case wherein a stabilized speed was obtained by deceleration from a high speed. As a result, the present inventors found that stabilizing a speed by deceleration from a high speed could shorten the time required to stabilize a speed as compared with the case wherein a speed was stabilized by acceleration from a low speed, could shorten the time accompanied by speed fluctuations, and was suitable for the elimination of a convey time shift, thereby reaching the present invention.

The present invention can therefore provide an image printing apparatus which can transfer toner images to predetermined positions on image recording sheets at the image transfer position without causing any image shift between the image recording sheets by conveying each image recording sheet with high accuracy so as to keep constant the convey time required for each image recording sheet to reach the image transfer position from the registration roller unit.

According to a primary aspect of the present invention, there is provide an image printing apparatus comprising an image printing unit which forms a toner image, an image carrier which carries the toner image formed by the image printing unit, an image transfer member which transfers the toner image carried on the image carrier onto an image recording sheet, registration roller unit which convey the image recording sheet toward an image transfer position at which the toner image is transferred onto the image recording sheet by the image transfer member, a sensor which is provided between the registration roller unit and the image transfer position to detect the image recording sheet, and a control unit which controls driving of the registration roller unit, wherein the control unit performs control to start driving the registration roller unit at a first sheet convey speed higher than a linear speed of a surface of the image carrier, measure a time required until a leading end of a conveyed image recording sheet is detected by the sensor after a driving signal for starting driving of the registration roller unit is output, compare the measured time with a preset reference time, determine, on the basis of a comparison result, a timing at which the sheet convey speed of the registration roller unit is reduced from the first sheet convey speed to a second sheet convey speed, reduce the sheet convey speed of the registration roller unit from the first sheet convey speed to the second sheet convey speed at the determined timing, and convey the image recording sheet to the image transfer position at the second sheet convey speed.

In addition to the image printing apparatus according to the main aspect described above, the present invention has subsidiary aspects such as, for example, image printing apparatuses described in claims 2 to 4 to be described later.

As is obvious from each aspect described above, according to the present invention, it suffices to perform only two-step drive control, i.e., starting the driving of the registration roller unit at the first sheet convey speed higher than the linear speed of the surface of the image carrier, measuring the time required until the leading end of a conveyed image recording sheet is detected by the sensor after a driving signal for the registration roller unit is output, and reducing the sheet convey speed of the registration roller unit to the second sheet convey speed at the timing based on the measurement result. This eliminates the necessity to perform complicated control of the technique disclosed in patent reference 1 and allows easy control.

In addition, the time required for each image recording sheet to reach the image transfer position can be made constant, and each image recording sheet can be transferred to a predetermined position with high accuracy. This can eliminate the problem of an image shift between image recording sheets. Furthermore, since the driving of the registration roller unit is started at the first sheet convey speed higher than the linear speed of the surface of the image carrier, a high-speed image printing apparatus with high productivity can be provided.

In other words, even variations in the start of driving of the registration roller unit, a delay in conveyance of an image recording sheet due to a slip, variations in initial sheet convey speed, and variations in the stop position of an image recording sheet at the nip portion of the registration roller unit can be easily corrected. This makes it possible to convey each image recording sheet from the registration roller unit to the image transfer position in a predetermined period of time at a predetermined timing.

The present invention is more specifically described in the following paragraphs by reference to the drawings attached only by way of example.

### BRIEF DESCRIPTION OF THE DRAWINGS

A more complete appreciation of the present invention, and many other attendant feature and advantages thereof, will become readily apparent as the same becomes better understood by reference to the following detailed description when considered in conjunction with the accompanying drawings in which like reference symbols and reference numerals indicate the same or similar components, wherein:

FIG. 1 is a sectional view showing the overall arrangement of a tandem type image printing apparatus which can print full-color images as an embodiment of an image printing apparatus of the present invention;

FIG. 2 is a block diagram schematically showing the arrangement of a control system in the embodiment of the present invention;

FIG. 3 is a conceptual view showing the position of a sensor with respect to registration roller unit in the embodiment of the present invention;

FIG. 4 is a flowchart for explaining operation associated with position control on an image recording sheet in the embodiment of the present invention; and

FIG. 5 is a view for explaining an example of a registration roller control method according to the embodiment of the present invention.

### DETAILED DESCRIPTION OF THE PREFERRED EMBODIMENT

A preferred embodiment of the present invention will be described in detail below with reference to the accompanying drawings.

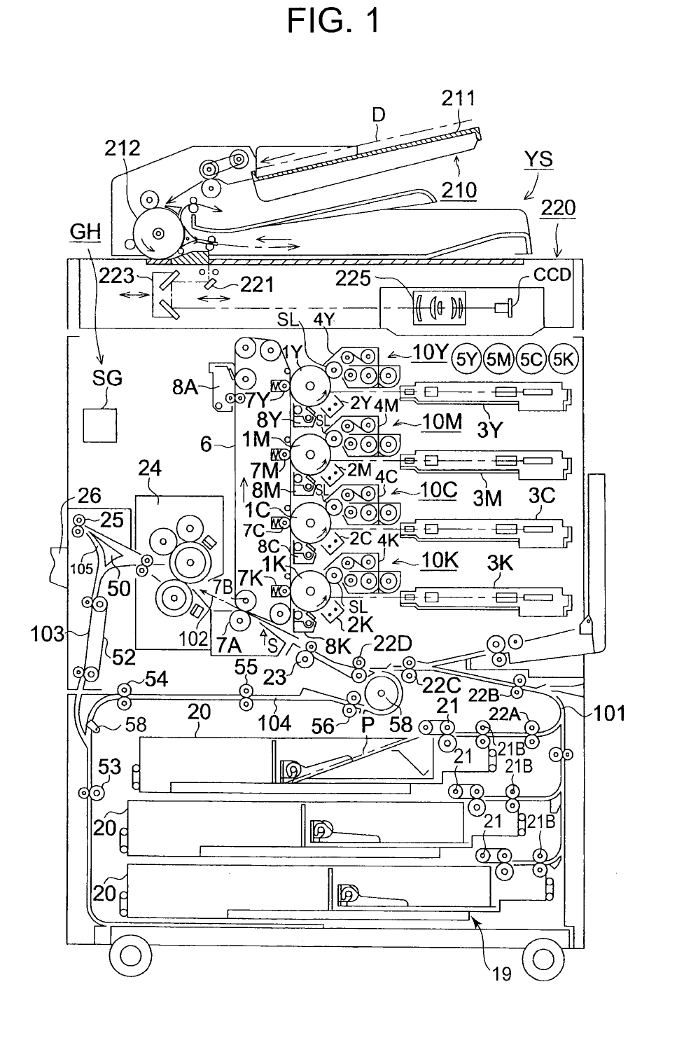

FIG. 1 is a view showing an overall image printing apparatus, which has a tandem form with a plurality of photosensitive bodies being vertically arrayed on an intermediate transfer body, and can print full-color images. An image printing apparatus body GH comprises a plurality of image printing units 10Y, 10M, 10C, and 10K, an intermediate transfer body 6 comprising a belt-like image carrier, a plurality of sheet convey path sections, a fixing device 24, and the like.

The image printing unit 10Y which prints yellow images includes a photosensitive body 1Y comprising a drum-like image carrier and includes devices arranged around the photosensitive body, including a charging device 2Y, an exposure device 3Y, a developing device 4Y, and a cleaning device 8Y having a blade.

The image printing unit 10M which prints magenta images includes a photosensitive body 1M comprising a drum-like image carrier, and includes a charging device 2M, an exposure device 3M, a developing device 4M, and a cleaning device 8M having a blade.

The image printing unit 10C which prints cyan images includes a photosensitive body 1C comprising a drum-like image carrier, and includes a charging device 2C, an exposure device 3C, a developing device 4C, and a cleaning device 8C having a blade.

The image printing unit 10K which prints black images includes a photosensitive body 1K comprising a drum-like image carrier, and includes a charging device 2K, an exposure device 3K, a developing device 4K, and a cleaning device 8K having a blade.

The charging devices and exposure devices for the respective colors constitute latent image forming units.

Note that each exposure device comprises a semiconductor laser exposure device including a laser source, f-θ lens, collimator lens, polygon mirror, and the like.

Each developing device includes a developing sleeve SL in which a magnet is fixed. This device carries a two-component developer comprising a toner and a carrier on the surface of the developing sleeve SL and conveys the developer to the developing area.

The intermediate transfer body 6 pivots while being supported by a plurality of rollers.

Note that the image carrier in the present invention is the intermediate transfer body 6 which carries a toner image immediately before it is transferred onto a final image recording sheet in this embodiment.

Primary image transfer members 7Y, 7M, 7C, and 7K comprising conductive rollers are arranged at positions which are located inside the intermediate transfer body 6 and face the respective photosensitive bodies described above. Each primary image transfer member performs primary transfer from the photosensitive body to the intermediate transfer body.

A transfer roller 7A is also provided as a secondary image transfer member for performing secondary transfer onto an image recording sheet, and is pressed against a backup roller 7B provided within the intermediate transfer body 6 through a belt.

Reference numeral 8A denotes a cleaning device having a blade for cleaning the surface of the intermediate transfer body 6.

The primary image transfer member 7Y is biased by a spring to press the intermediate transfer body 6 against the photosensitive body.

The fixing device 24 includes a heating roller and a press roller.

Referring to FIG. 1, reference numerals 5Y, 5M, 5C, and 5K denote toner replenishment devices which replenish toner and are provided in correspondence with the developing devices of the respective colors.

An image reader YS is provided on the image printing apparatus body GH. The image reader YS comprises an automatic document convey device 210 and a scanning exposure device 220.

The scanning exposure device 220 includes a first block 221 integrally comprising an irradiation lamp and a first mirror, a second block 223 integrally comprising second and third mirrors, an imaging lens 225, and an image sensor CCD.

Note that the automatic document convey device 210 comprises a two-sided document convey unit, continuously reads images on many documents D fed from on a document table 211, and stores the resultant data in a memory M1. This operation is convenient for copying, facsimile transmission, and the like of many documents.

A paper feed unit 19 which feeds image recording sheets P is provided under the image printing apparatus body GH.

The paper feed unit 19 includes a paper feed tray 20 which stores image recording sheets P, paper feed rollers 21 which feed the image recording sheets P, and convey rollers 21B and 22A provided downstream of the paper feed rollers 21, and feeds the image recording sheets P to a first sheet convey path 101 on the downstream side.

The first sheet convey path 101 serving as a common sheet convey path is provided with convey rollers 22B, 22C, and 22D, and conveys the image recording sheet P fed from each paper feed tray to registration roller unit 23.

The registration roller unit 23 are provided at a position near the image transfer position of a secondary image transfer member 7A.

A drive source M for the registration roller unit 23 independently drives only the registration roller unit 23, and preferably uses a stepping motor. This motor is small in speed fluctuations, and can reduce fluctuations at the time of switching of speeds. The driving of the drive source M is controlled by a control unit SG.

The registration roller unit 23 are not driven and are stopped when the image recording sheet P is conveyed through the first sheet convey path 101.

The conveyed image recording sheet P is abutted against the registration roller unit 23 at rest, and the leading end of the image recording sheet P enters the nip portion of the registration roller unit 23 while its skew with respect to the convey direction of the image recording sheet is corrected.

Starting to drive the registration roller unit 23 at a predetermined timing with respect to a toner image formed on the intermediate transfer body 6 allows the image recording sheet P whose skew with respect to the convey direction is corrected to be conveyed to the image transfer position.

Note that as sheet convey paths, in addition to the above first sheet convey path 101, there are provided a second sheet convey path 102 extending from the registration roller unit 23 to delivery rollers 25, a third sheet convey path 103 extending from a sheet convey path switching member 50 to reversal rollers 53 through a belt-type sheet convey member 52, a fourth sheet convey path 104 which reverses the image recording sheet P conveyed to the third sheet convey path 103 and extends to the convey rollers 22D through convey rollers 54, 55, 56, and 58, and a fifth sheet convey path 105 which reverses the image recording sheet P fed into the third sheet convey path 103, and extends to the delivery rollers 25 through the sheet convey path switching member 50.

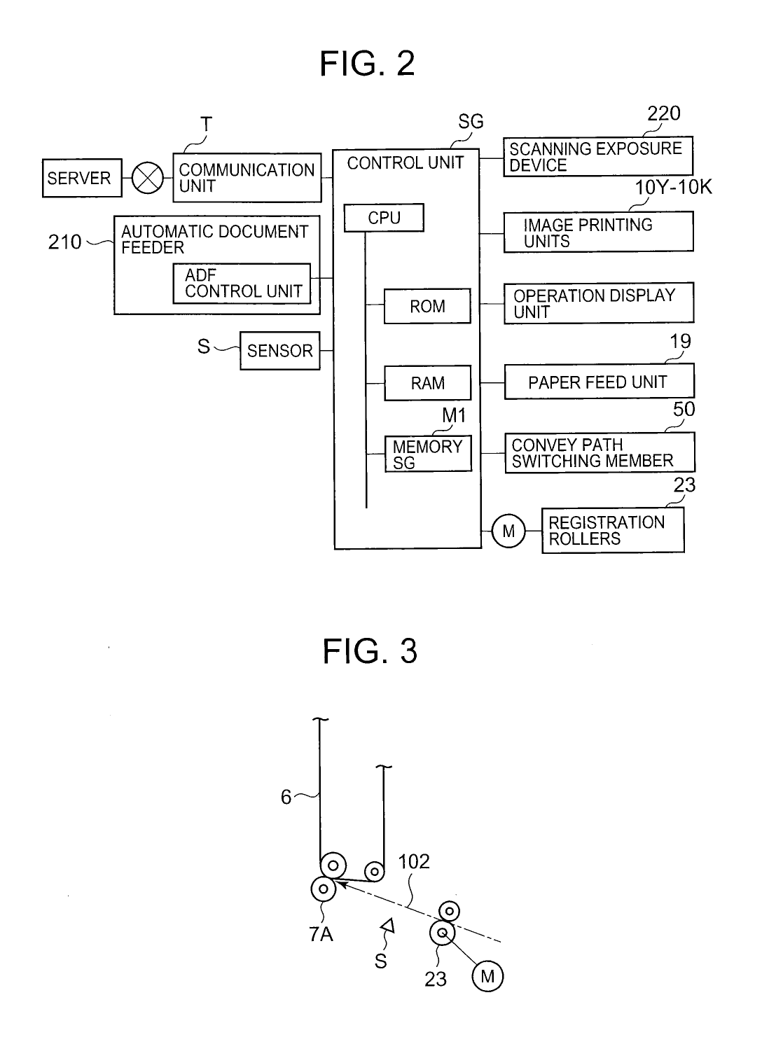

FIG. 2 is a block diagram showing the arrangement of a control system in the embodiment of the present invention.

Referring to FIG. 2, the control unit SG comprises a ROM, RAM, CPU, memory M1, and the like, and executes various kinds of control, e.g., control of the image printing unit, control of the scanning exposure device, control of display of an operation display unit, control of the paper feed unit 19 and a sheet convey path switching member 50 for the conveyance of the image recording sheet P, control of image processing for image data, and control of the drive source M which drives the registration roller unit 23 on the basis of a detection signal from the sensor S which detects the image recording sheet P.

An ADF control unit controls the automatic document convey device 210 on the basis of a command from the control unit SG.

The control unit SG is connected to a LAN or a public line such as the Internet through a communication unit T, and can communicate with another information device such as a server.

The overall operation accompanying an image printing process will be described next briefly with reference to FIG. 1.

Documents D placed on the document table 211 of the automatic document convey device 210 are separated one by one by a separation device. The separated document is conveyed to the reading position by the convey rollers, a rotating drum 212, and the like on the downstream side, and an image is read by the scanning exposure device 220.

The document D conveyed to the reading position is irradiated with an irradiation lamp. Reflected light from the document D is formed into an image on the image sensor CCD through the above mirrors and the imaging lens 225, and is read.

The image data comprising the analog signal read by the image sensor CCD is subjected to processing such as A/D conversion, shading correction, and image compression in an image processing unit provided in the control unit SG, and the resultant data is stored in the memory M1 in the control unit SG.

The image data stored in the memory M1 is read out in accordance with an image printing process and sent to exposure devices 3Y, 3M, 3C, and 3K to write images.

The exposure devices 3Y, 3M, 3C, and 3K irradiate the uniformly charged surfaces of the photosensitive bodies 1Y, 1M, 1C, and 1K with laser beams modulated in accordance with the image data, thereby forming electrostatic latent images corresponding to the image data.

Exposure is performed for each color at a proper timing, and the formed electrostatic latent image is developed as a toner image of each color by a corresponding developing device.

The toner images of the respective colors are sequentially transferred onto the intermediate transfer body 6 under the operation of the primary image transfer members 7Y, 7M, 7C, and 7K and are superimposed on the intermediate transfer body 6, thereby forming a full-color toner image.

The toner image is conveyed to the image transfer position by the rotation of the intermediate transfer body 6.

The surface of each photosensitive body which has passed through the transfer area is cleaned by the cleaning device to prepare for next image printing operation.

The image recording sheet P is fed from the paper feed unit 19 to the registration roller unit 23 in accordance with the above image printing process. The driving of the registration roller unit 23 is started in accordance with the timing of travel of the toner image carried on the intermediate image carrier 6 to the image transfer position. The image recording sheet P which has been temporarily stopped at the registration roller unit 23 is then conveyed to the image transfer position of the secondary image transfer member 7A.

At the image transfer position, the toner image on the intermediate transfer body 6 is transferred onto the image recording sheet P by the operation of the secondary image transfer member 7A to which a predetermined voltage is applied. The toner image is fixed on the image recording sheet P by the fixing device 24 provided on the second sheet convey path 102 by heating and pressing. After fixing, the image recording sheet is delivered onto a tray 26 provided outside the apparatus through the delivery rollers 25.

At this time, the sheet convey path switching member 50 is held at the position indicated by the solid lines in FIG. 1 and has released the second sheet convey path 102.

After the toner image is transferred by the secondary image transfer member 7A, the intermediate transfer body 6 is cleaned by the cleaning device 8A.

The above description has exemplified the case wherein the image is printed on one surface of the image recording sheet P. In the mode of printing images on the two surfaces of the image recording sheet P, the following convey route is set for the image recording sheet P.

After fixing processing, the image recording sheet P having an image formed on its one surface is guided to the third sheet convey path 103 by sheet convey path switching operation of the sheet convey path switching member 50. The sheet is then stopped while its trailing end is clamped by the reversal rollers 53.

Subsequently, the sheet is fed upward by the rotation of the reversal rollers 53 which are rotated/driven in a direction opposite to the above direction, and is fed into a fourth convey path 104 released by convey path switching by the sheet convey path switching member 50. As a consequence, the obverse and reverse surfaces of the sheet are reversed.

The image recording sheet P is further conveyed by the rollers 55 and 56 and the drum 58 and is abutted against the registration roller unit 23 which have already been at rest.

The image recording sheet P is conveyed to the image transfer position by the registration roller unit 23 in accordance with the timing of travel of the toner image carried on the intermediate image carrier 6 to the image transfer position, and the toner image is transferred to the reverse surface by the operation of the secondary image transfer member 7A.

After fixing processing, the sheet is delivered out of the apparatus through the delivery rollers 25.

At this time, the second sheet convey path 102 is released by the sheet convey path switching member 50.

Note that if the mode of reversing and delivering the image recording sheet P having an image printed only on its obverse surface or images printed on the two surfaces for the sake of page registration is selected, the following convey route is set for the image recording sheet P.

The image recording sheet P having undergone fixing processing is guided to the third sheet convey path 103 and is temporarily stopped while the trailing end of the image recording sheet P, viewed from the traveling direction of the image recording sheet, is clamped by the belt-type sheet convey member 52.

Subsequently, as the belt-type sheet convey member 52 is rotated reversely, the image recording sheet P is conveyed upward, and is delivered on the fifth sheet convey path 105 onto the tray 26 through the sheet convey path switching member 50 and the delivery rollers 25.

In the present invention, in order to control the conveyance of the image recording sheet P, the sensor S which detects the image recording sheet P is provided between the registration roller unit 23 and the image transfer position of the secondary sheet transfer member 7A.

FIG. 3 shows the position of the sensor S with respect to the registration roller unit 23 in the embodiment of the present invention.

Referring to FIG. 3, the sensor S for detecting the leading end of the image recording sheet P comprises a transmission type optical sensor and is provided between the registration roller unit 23 and the image transfer position of the secondary sheet transfer member 7A.

When the leading end of the image recording sheet P is detected by the sensor S, the detection signal is transmitted to the control unit SG. The control unit SG determines the timing of speed reduction by measuring the time required until the leading end of the conveyed image recording sheet P is detected by the sensor S after a driving signal for starting to drive the registration roller unit 23 is output on the basis of a detection signal from the sensor S. The control unit SG then conveys the image recording sheet to the image transfer position upon reducing the sheet convey speed of the registration roller unit 23 from the first sheet convey speed to the second sheet convey speed at the determined timing. With this control, the convey time taken for the image recording sheet P to reach the image transfer position from the registration roller unit 23 can be made constant, and the image recording sheet P can be conveyed with high accuracy. This makes it possible to transfer a toner image onto a predetermined position on the image recording sheet P at the image transfer position, thereby preventing the occurrence of an image shift between image recording sheets.

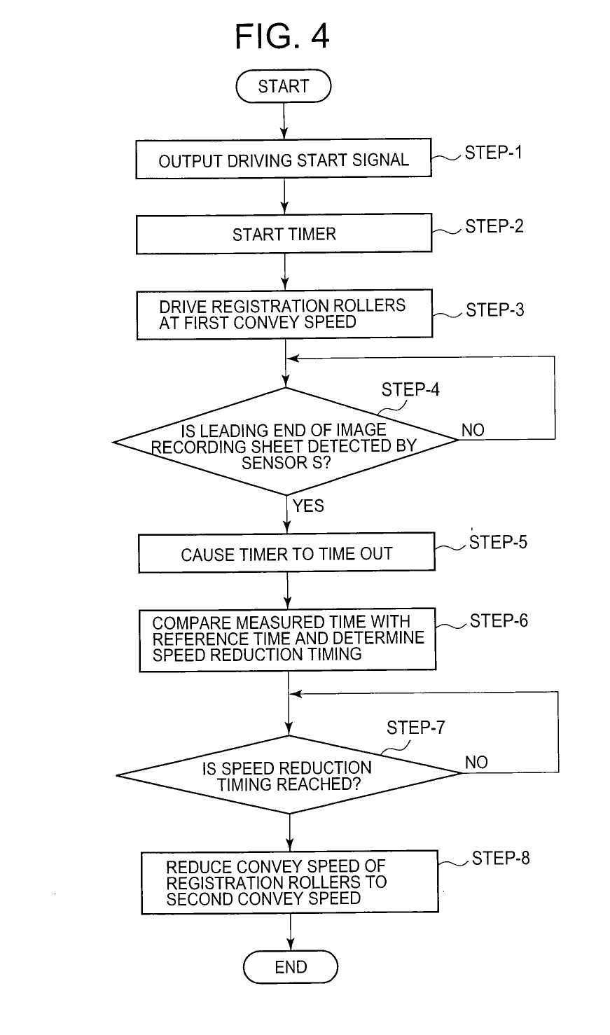

Position control on image recording sheets in the embodiment of the present invention will be described in detail with reference to the flowchart of the FIG. 4.

A driving start signal for starting the driving of the registration roller unit 23 is output from the control unit SG to the drive source M (Step-1). At this time, the control unit SG starts a timer to start measuring the time at the same time when outputting a driving start signal (Step-2).

As the driving of the drive source M is started upon reception of the driving start signal, the driving of the registration roller unit 23 is started at the first sheet convey speed (Step-2). With this operation, the image recording sheet P is conveyed toward the image transfer position.

The sheet convey speed achieved by driving the registration roller unit 23 until the image recording sheet P reaches the sensor S is set to the first sheet convey speed higher than the linear speed of the surface of the intermediate transfer body 6 as an image carrier. This makes it possible to shorten the time required to convey the image recording sheet P and realize high-speed image printing operation.

Subsequently, the leading end of the conveyed image recording sheet P is detected by the sensor S (Step-4).

When the sensor S detects the leading end of the image recording sheet P, the detection signal is transmitted to the control unit SG.

Upon receiving the detection signal, the control unit SG causes the timer to time out to terminate the time measurement (Step-5). With this operation, the control unit SG completes the measurement of the time from the instant at which a driving signal for starting the driving of the registration roller unit 23 is output to the instant at which a detection signal is received. The measured time is equal to the time required for the image recording sheet P to reach the sensor S from the registration roller unit 23.

Subsequently, the control unit SG calculates and determines the timing at which the sheet convey speed of the registration roller unit 23 is reduced to the second sheet convey speed on the basis of the comparison between the measured time and the reference time set in the control unit SG (Step-6).

The control unit SG determines whether the determined speed reduction timing is reached (Step-7).

When the determined speed reduction timing is reached, the control unit SG controls the drive source M so as to reduce the sheet convey speed of the registration roller unit 23 from the first sheet convey speed to the second sheet convey speed (Step-8).

The second sheet convey speed to which the sheet convey speed of the registration roller unit 23 is reduced from the first sheet convey speed is preferably the same as the linear speed of the surface of the intermediate transfer body 6. This same speed does not indicate that the second sheet convey speed is perfectly the same as the linear speed, but may indicate that they are substantially the same and have a slight speed difference within the range of plus/minus 3%.

Upon executing the above speed reduction, the control unit SG clears the timer and waits for control on the next image recording sheet P.

In addition, the rotation of the registration roller unit 23 is stopped after the image recording sheet is fed out.

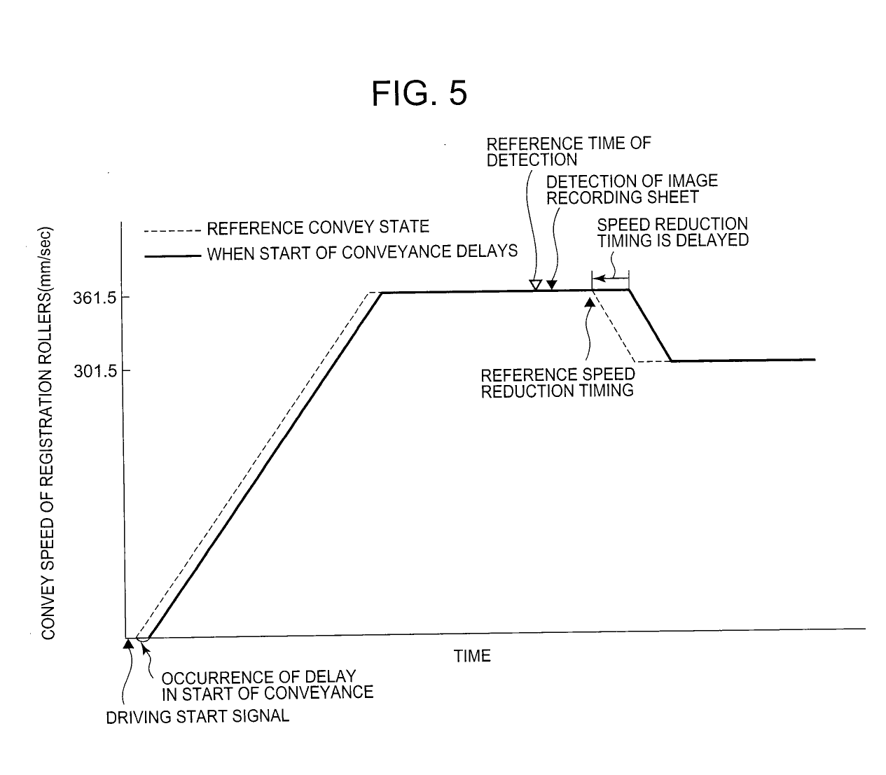

A concrete example of convey control on the image recording sheet P will be described with reference to FIG. 5.

Referring to FIG. 5, the ordinate represents the sheet convey speed (unit: mm/sec) of the registration roller unit 23; and the abscissa, the time (msec). In addition, the broken line indicates a normal convey state, and the solid line indicates a case wherein the start of the conveyance of the image recording sheet P is delayed by a slip between the image recording sheet and the registration roller unit 23.

Note that the linear speed of the surface of the intermediate transfer body and the second sheet convey speed in this embodiment are set to 301.5 mm/sec, and the first sheet convey speed of the registration roller unit 23 for conveying the image recording sheet P is set to 361.5 mm/sec higher than the second sheet convey speed.

Referring to FIG. 5, when the driving start signal output from the control unit SG is input to the drive source M, the driving of the drive source M is started with a slight time difference, and the sheet convey speed of the registration roller unit 23 is accelerated to the first sheet convey speed.

When the driving of the registration roller unit 23 is started, the image recording sheet P is conveyed at the first sheet convey speed which is a high speed. When the leading end of the image recording sheet P is detected by the sensor S, the control unit SG determines a speed reduction timing by comparing a preset reference time with the measured time required for the image recording sheet P to reach the sensor S after a driving signal is output. If, for example, normal conveyance is performed and the present reference time coincides with the measured time, the convey state indicated by the broken line appears. In this case, the sheet convey speed of the registration roller unit 23 is reduced to the second sheet convey speed at a reference speed reduction timing.

The image recording sheet P is conveyed to the image transfer position at the second sheet convey speed equal to the linear speed of the surface of the intermediate transfer body after speed reduction, and a toner image on the intermediate transfer body is transferred onto the image recording sheet P.

The solid line indicates a case wherein the start of conveyance of the image recording sheet P is delayed by a slip between the image recording sheet and the registration roller unit 23. In this case, the time required for the sensor S to detect the image recording sheet P is delayed with respect to the reference time.

In this case, if the time required between the instant at which the driving of the registration roller unit 23 is started and the instant at which the leading end of the image recording sheet P conveyed by the registration roller unit 23 at the first sheet convey speed is detected by the sensor S is delayed with respect to the present reference time by, for example, 1.0 msec, the sheet convey speed of the registration roller unit 23 which is 361.5 mm/sec is reduced to the second sheet convey speed, i.e., 301.5 mm/sec, at a speed reduction timing delayed from the time point indicated as a reference speed reduction timing by 6.0 msec.

This makes it possible to always keep constant the relationship between the image recording sheet P at the image transfer position and a toner image on the intermediate transfer body.

A convey delay of 1.0 msec described above can be converted into a length by convey delay length of image recording sheet=361.5 mm/sec×1.0 msec. The convey delay length of the image recording sheet P is 0.3615 mm.

How much the convey time based on the first sheet convey speed should be delayed to compensate for this convey delay is obtained by 0.3615 mm/(361.5 mm/sec−301.5 mm/sec). That is, 6.025 msec is obtained.

In contrast to the above, if, for example, the timing is early by 1.0 msec, the sheet convey speed is reduced to the second sheet convey speed, i.e., 301.5 mm/sec, at the timing earlier than the reference speed reduction timing by 6.0 msec.

This makes it possible to keep constant the time between the instant at which the driving of the registration roller unit 23 is started and the instant at which the image recording sheet P reaches the image transfer position and match the sheet convey speed with the linear speed of the surface of the intermediate transfer body before the image recording sheet P reaches the image transfer position. Therefore, the relationship between the intermediate transfer body at the image transfer position and the speed of the image recording sheet P can always be maintained constant.

### EXPERIMENTAL EXAMPLE

The control on the registration roller unit 23 in the embodiment of the present invention was performed to print images on 3,000 image recording sheets, and the distances from the leading ends of the respective image recording sheets to the positions where toner images were formed were measured. If the difference between the measured maximum and minimum distances is regarded as a positional shift amount, the maximum positional shift amount is 0.2 mm. The level of this positional shift satisfies the condition of accuracy required for a quick printer.

### COMPARATIVE EXAMPLE

Images were printed on 3,000 image recording sheets in the same manner as described in the above embodiment without using the control scheme for the registration roller unit 23 in the present invention, and the maximum positional shift amount was measured in the same manner as described above. The maximum positional shift amount was 0.6 mm, which was much larger than that in the embodiment.

Note that the embodiment has exemplified the case wherein an intermediate transfer body is used as an image carrier from which an image is transferred onto an image recording sheet. However, the present invention can be suitable for an image printing apparatus which transfers a toner image from a photosensitive body onto an image recording sheet without using any intermediate transfer body.

What is claimed is:

1. An image printing apparatus which prints an image, comprising:
an image printing unit which forms a toner image;
an image carrier which carries the toner image formed by said image printing unit;
an image transfer member which transfers the toner image carried on said image carrier onto an image recording sheet;
registration roller unit which convey the image recording sheet toward an image transfer position at which the toner image is transferred onto the image recording sheet by said image transfer member;
a sensor which is provided between said registration roller unit and the image transfer position to detect the image recording sheet; and
a control unit which controls driving of said registration roller unit,
wherein said control unit performs control to start driving said registration roller unit at a first sheet convey speed higher than a linear speed of a surface of said image carrier, measure a time required until a leading end of a conveyed image recording sheet is detected by said sensor after a driving signal for starting driving of said registration roller unit is output, compare the measured time with a preset reference time, determine, on the basis of a comparison result, a timing at which the sheet convey speed of said registration roller unit is reduced from the first sheet convey speed to a second sheet convey speed, reduce the sheet convey speed of said registration roller unit from the first sheet convey speed to the second sheet convey speed at the determined timing, and convey the image recording sheet to the image transfer position at the second sheet convey speed.

2. An apparatus according to claim 1, wherein said control unit performs control so as to keep constant the time between the instant at which the driving signal is output and the instant at which the image recording sheet reaches the image transfer position.

3. An apparatus according to claim 1, wherein a drive source which drives said registration roller unit comprises a stepping motor.

4. An apparatus according to claim 1, wherein the second sheet convey speed is equal to the linear speed of the surface of said image carrier.
